(19) United States
(12) Patent Application Publication
(10) Pub. No.: US 2026/0138551 A1
(43) Pub. Date: May 21, 2026

(54) GRILLE GUARDS AND ASSOCIATED SYSTEMS AND METHODS

(71) Applicant: Holt Sales and Service, LLC, Des Moines, IA (US)

(72) Inventor: Jeremy Drever, Ankeny, IA (US)

(73) Assignee: Holt Sales and Service, LLC, Des Moines, IA (US)

(21) Appl. No.: 19/448,699

(22) Filed: Jan. 14, 2026

Related U.S. Application Data
(63) Continuation of application No. 19/182,309, filed on Apr. 17, 2025.
(60) Provisional application No. 63/753,305, filed on Feb. 3, 2025.
(60) Provisional application No. 63/635,362, filed on Apr. 17, 2024.

(51) Int. Cl. B60R 19/52

(52) U.S. Cl. CPC B60R 19/52; B60R 2019/522

(57) ABSTRACT

A grille guard system, comprising a grille guard, a first latch, and a second latch. The first latch comprising a handle, a cam assembly, a backplate comprising a U-bolt, and a first latch housing. The second latch comprising a handle, a cam assembly, a backplate comprising a U-bolt, and a second latch housing. A lift assist system in operational communication with the grille guard assembly. A sensor cap comprising an angled opening configured to be placed over a vehicle sensor and constrain the sensor field of view.

### CROSS-REFERENCE TO RELATED APPLICATION(S

This application is a continuation of U.S. Application 19/182,309, filed April 17, 2025, and entitled Grille Guards and Associated Systems and Methods which claims the benefit under 35 U.S.C. § 119(e) to U.S. Provisional Application 63/635,362, filed April 17, 2024, and entitled Quick Release Grill Guard and Associated Systems and Methods, and U.S. Provisional Application 63/753,305, filed February 3, 2025, and entitled Parking Sensor Redirecting Cap / Cover, each of which is hereby incorporated herein by reference in its entirety for all purposes.

### TECHNICAL FIELD

The disclosure relates to devices, systems and methods for protecting the grilles of semis, tractor trailers, trucks and other vehicles. More specifically, to devices and methods of using is an adjustable grille guard which is capable of quick release so as to be easily rotated away from the protected grille.

### BACKGROUND

Trucks, such as semi-trucks and tractor trailers are ubiquitous on the roads at all hours of day and night, and are integral to the world’s over-the-road transportation and hauling of goods. These trucks (which include, but are not limited to semis and tractor trailers) are quite expensive, and require significant investment.

Such trucks are typically fitted with a grille at the front to allow for air intake and engine cooling. In many implementations, these grills have aesthetic properties as well as functional ones. However, with the number of deer and other hazards that are present on the roads, collisions that damage these grills can lead to significant repair costs and downtime. Considering the continual increase in the price of fuel and other aspects of modern globalization, it is crucial for companies employing such methods of transport to keep their overall costs low and productivity high.

### BRIEF SUMMARY

In Example 1, a grille guard system, comprising a grille guard, a first latch, and a second latch. The first latch comprising a handle, a cam assembly, a backplate comprising a U-bolt, and a first latch housing. The second latch comprising a handle, a cam assembly, a backplate comprising a U-bolt, and a second latch housing.

Example 2 relates to the grille guard system of any of claims 1 and 3-14, further comprising a lift assist system in operational communication with the grille guard assembly.

Example 3 relates to the grille guard system of any of claims 1-2 and 4-14, wherein the lift assist system further comprises at least one torsion bar disposed between the first latch and second latch and configured to urge the grill guard into an upright position.

Example 4 relates to the grille guard system of any of claims 1-3 and 5-14, wherein at least one of the first latch housing and second latch housing comprises a detection offset.

Example 5 relates to the grille guard system of any of claims 1-4 and 6-14, wherein the at least one detection offset is configured to accommodate a sensor path of a sensor.

Example 6 relates to the grille guard system of any of claims 1-5 and 7-14, wherein the sensor is radar or lidar.

Example 7 relates to the grille guard system of any of claims 1-6 and 8-14, wherein each of the first latch and second latch cam assembly comprises a camshaft and a cam configured to assist in the smooth actuation of the grille guard between positions.

Example 8 relates to the grille guard system of any of claims 1-7 and 9-14, wherein the cam comprises a clasp and a driven catch configured to selectively engage the backplate U-bolt.

Example 9 relates to the grille guard system of any of claims 1-8 and 10-14, wherein the camshaft is rotationally coupled to the handle via an internal axle.

Example 10 relates to the grille guard system of any of claims 1-9 and 11-14, wherein the internal axle comprises a D-shaped cross-section configured to lock into a corresponding D-shaped axle opening in the cam assembly.

Example 11 relates to the grille guard system of any of claims 1-10 and 12-14, wherein the cam comprises an internal bearing disposed within a cam opening defined in a cam body, the internal bearing enabling smooth rotational movement of the cam about the camshaft during actuation.

Example 12 relates to the grille guard system of any of claims 1-11 and 14, wherein at least one rotating bolt is disposed through the cam assembly and is secured within paired outer plates and friction plates.

Example 13 relates to the grille guard system of any of claims 1-12 and 14, wherein the rotating bolt configured to urge the cam into rotation upon upward actuation of the handle.

Example 14 relates to the grille guard system of any of claims 1-13, wherein the cam assembly is enclosed between a first cam housing and a second cam housing, each housing defining a cam housing opening, the first cam housing and second cam housing secured by one or more fasteners to maintain alignment and structural integrity of the assembly during operation.

In Example 15, a grille guard system for use with a vehicle, comprising a grille guard; a first latch comprising: a handle and a first latch housing comprising a detection offset; a second latch comprising a handle and a second latch housing; and a lift assist system comprising at least one torsion bar.

Example 16 relates to the grille guard system of any of claims 15 and 17-23, wherein the at least one torsion bar comprises an elongated resilient shaft configured to store elastic potential energy when the guard is rotated away from the vehicle.

Example 17 relates to the grille guard system of any of claims 15-16 and 18-23, wherein the at least one torsion bar comprises a torsion end coupled to a leverage rod extending into a rod securement positioned within one of the latches, such that actuation of the latch applies torsional deformation to the at least one torsion bar.

Example 18 relates to the grille guard system of any of claims 15-17 and 19-23, further comprising a coverage portion disposed over the at least one torsion bar.

Example 19 relates to the grille guard system of any of claims 15-18 and 20-23, wherein: the lift assist system comprises: a first torsion bar comprising a first leverage rod; and a second torsion bar comprising a first leverage rod, and the first latch comprises a first rod securement; and the second latch comprises a second rod securement, wherein the first and second torsion bars are in rotational communication with the first and second latches via the interaction of the first and second leverage rods with the first and second rod securements.

Example 20 relates to the grille guard system of any of claims 15-19 and 21-23, wherein the first and second rod securements comprise a securing catch configured to maintain the torsion bar in locked rotational communication with the latch during operation.

Example 21 relates to the grille guard system of any of claims 15-20 and 22-23, further comprising a bracket comprising a vehicle coupling portion configured to mount the latch to a fixed portion of the vehicle.

Example 22 relates to the grille guard system of any of claims 15-21 and 23, wherein the bracket further comprises a mounting plate.

Example 23 relates to the grille guard system of any of claims 15-22, wherein the bracket comprises a portion that forms part of a backplate on the first or second latch.

In Example 24 a sensor cap comprising an angled opening configured to be placed over a vehicle sensor and constrain the sensor field of view.

In Example 25, a grille guard latch, comprising: a handle; a cam assembly, comprising: a cam comprising a clasp and a catch; and a rotating bolt configured to urge the catch and clasp in response to rotation of the handle; a backplate comprising a U-bolt in operational locking communication with the clasp; and a housing comprising a detection offset, wherein the urging of the catch and clasp grasps or releases the U-bolt from the clasp to allow for selective rotation of the housing relative to the backplate.

Example 26 relates to the grille guard latch of any of claims 25 and 27-30, wherein the detection offset comprises a recessed portion configured to accommodate a sensor field of view of a vehicle-mounted radar or lidar system.

Example 27 relates to the grille guard latch of any of claims 25-26 and 28-30, wherein the detection offset defines a trapezoidal void formed in the latch housing and aligned to permit an unobstructed sensor field of view of at least 120 degrees.

Example 28 relates to the grille guard latch of any of claims 25-27 and 29-30, wherein the detection offset comprises a geometry adapted to conform to a sensor path.

Example 29 relates to the grille guard latch of any of claims 25-28 and 30, wherein the latch further comprises a bracket configured to align the detection offset relative to a forward-facing sensor integrated into the vehicle.

Example 30 relates to the grille guard latch of any of claims 25-29, in operational communication with a grille guard assembly and at least one torsion bar configured to provide lift assist.

While multiple embodiments are disclosed, still other embodiments of the grille guard will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A shows a perspective view of a grille guard system, according to one implementation.

FIG. 1B shows a front view of a grill guard system, according to one implementation.

FIG. 1C shows a perspective view of a grill guard system is an unlocked / rotated down position, according to one implementation.

FIG. 2A is a front view of a grill guard system, according to one implementation.

FIG. 2B is a front view of a grill guard system having a detection offset, according to one implementation.

FIG. 2C is a close up view of a grill guard system having a detection offset, according to one implementation.

FIG. 3A is a perspective view of a grill guard system having a detection offset, according to one implementation.

FIG. 3B is a perspective view of a grill guard system having a detection offset, according to one implementation.

FIG. 4 is a perspective view of a grill guard system having a detection offset, according to one implementation.

FIG. 5 is a side view of a grill guard system having a detection offset, according to one implementation.

FIG. 6A is a side view of a grill guard system having a detection offset, according to one implementation.

FIG. 6B is a side view of a grill guard system having a detection offset, according to one implementation.

FIG. 7 is a rear view of a grill guard system having a detection offset, according to one implementation.

FIG. 8 is a close-up view of a grill guard system having a cam assembly, according to one implementation.

FIG. 9 is a close-up view of a bracket of a grill guard system having a cam assembly, according to one implementation.

FIG. 10 is an isolated view of a cam assembly, according to one implementation.

FIG. 11A is an expanded view of a cam assembly, according to one implementation.

FIG. 11B is a further expanded view of a portion of the cam assembly of FIG. 11A, according to one implementation.

FIG. 12 is a rear view of a bracket and cam assembly, according to one implementation.

FIG. 13A is a side view of a bracket and cam assembly, according to one implementation.

FIG. 13B is a side view of a bracket and cam assembly, according to one implementation.

FIG. 14A is a side view of a bracket and cam assembly is a locked position, according to one implementation.

FIG. 14B is a side view of a bracket and cam assembly in an open position, according to one implementation.

FIG. 15 is a rear view of a cam assembly, according to one implementation.

FIG. 16A is a perspective view of a grill guard system having a torsion bar lift assist system, according to one implementation.

FIG. 16B is a rear view of a grill guard system having a torsion bar lift assist system, according to one implementation.

FIG. 16C is a rear view of a grill guard system having a torsion bar lift assist system, according to one implementation.

FIG. 16D is a close-up rear view of a torsion bar lift assist system, according to one implementation.

FIG. 17A is a rear view of a torsion bar lift assist system, according to one implementation.

FIG. 17B is a close-up rear view of a torsion bar lift assist system and bracket, according to one implementation.

FIG. 17C is a close-up rear view of a torsion bar lift assist system, according to one implementation.

FIG. 17D is a close-up rear view of a torsion bar lift assist system, according to one implementation.

FIG. 17E is a close-up rear view of a torsion bar lift assist system, according to one implementation.

FIG. 17F is a close-up rear view of a torsion bar lift assist system, according to one implementation.

FIG. 18 is a close-up rear view of a grill guard system bracket, according to one implementation.

FIG. 19 is a close-up side view of a grill guard system bracket, according to one implementation.

FIG. 20 is an expanded view of a grill guard system bracket, according to one implementation.

FIG. 21A is an expanded view of a grill guard system bracket, according to one implementation.

FIG. 21B is an expanded view of two brackets on a grill guard system, according to one implementation.

FIG. 22 is a perspective view of a cap / cover configured to redirect sensor signals, according to one implementation.

FIG. 23 is a side view of a vehicle having a sensor and installed grille guard, according to one implementation.

FIG. 24 is a side view of a vehicle sensor and installed grille guard using an installed sensor cap, according to one implementation.

### DETAILED DESCRIPTION

Exemplary implementations of the disclosed apparatus, systems and methods are herein described with references to the accompanying illustrations. It is to be understood that other implementations may be utilized and structural and functional changes may be made without departing from the respective scope of the disclosure. As such, the instant description is presented by way of illustration only and should not limit in any way the various alternatives and modifications that may be made to the illustrated implementations and still be within the spirit and scope of the disclosure.

As discussed herein, it is an object of the disclosed apparatus, systems and methods (collectively, the “grille guard”) to provide a protective covering for the grille of a semi, tractor trailer, truck, including pick-up trucks, SUVs and the like or other automobiles (“vehicle”) which is easy to pivot away from the vehicle. While references are made to the grille guard and vehicle throughout, this designation is made for brevity and in no way to reduce the scope of the various implementations and embodiments of the instant disclosure.

Exemplary implementations of the grille guard comprise a grille guard and a bracket. The grille guard may also include a latching system which is configured to allow for the easy movement of the grille guard between “open” and “closed” positions via a hinge. In alternate implementations on smaller passenger trucks and SUVs, the guards can be mounted directly to the vehicle via a bracket, like that described below, the guard may be directly affixed to the vehicle via a bracket without the optional latch.

In various implementations, the grille guard is curved to closely surround the front of the vehicle and prevent it from damage. In various implementations, the grille guard has a metal frame, such as steel, and an optional coating, such as a PVC coating to prevent natural wear and corrosion on the metal frame. In various implementations, the metal frame is high-tensile steel, such as 8 gauge high-tensile steel. Various additional materials, coatings, and grille guard shapes are possible and would be understood by those of skill in the art.

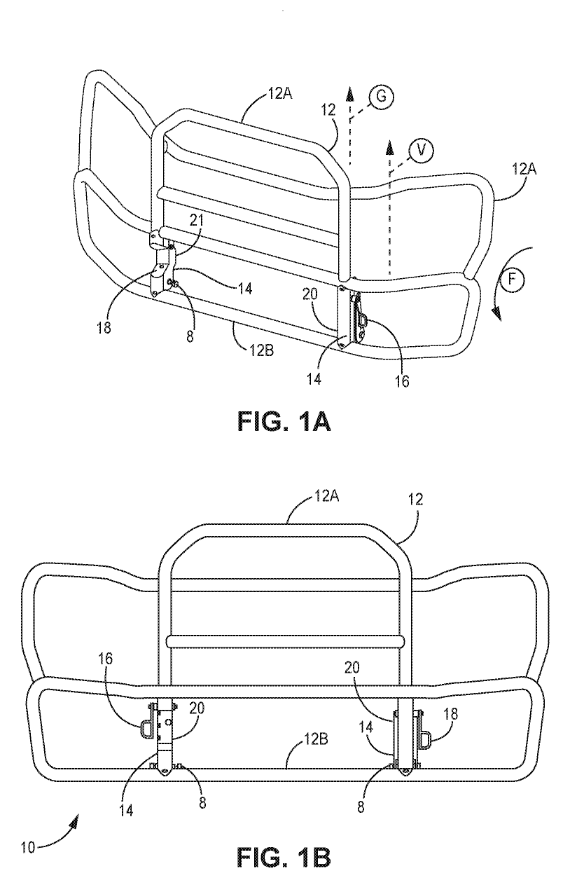

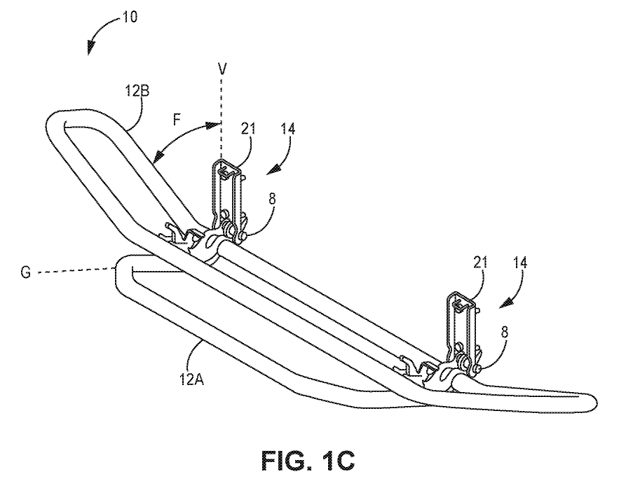

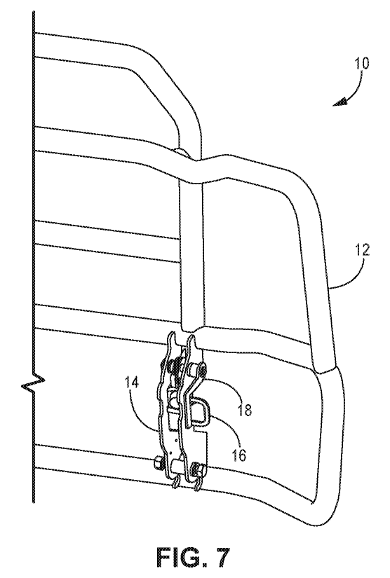

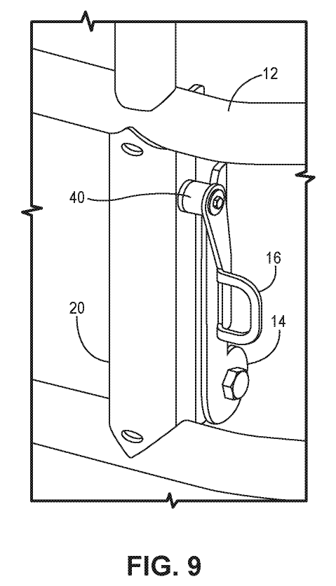

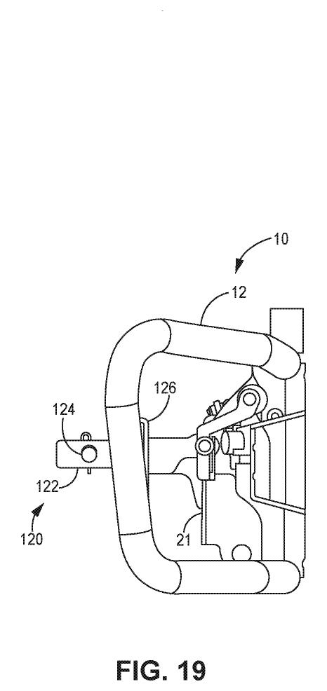

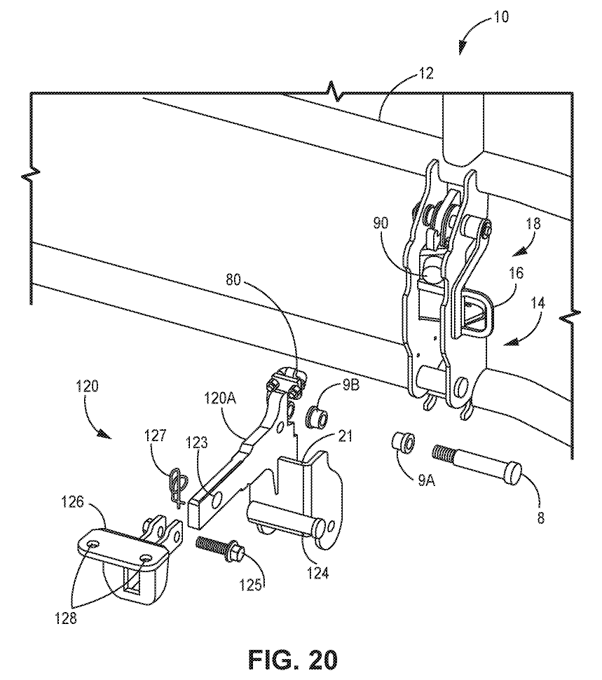

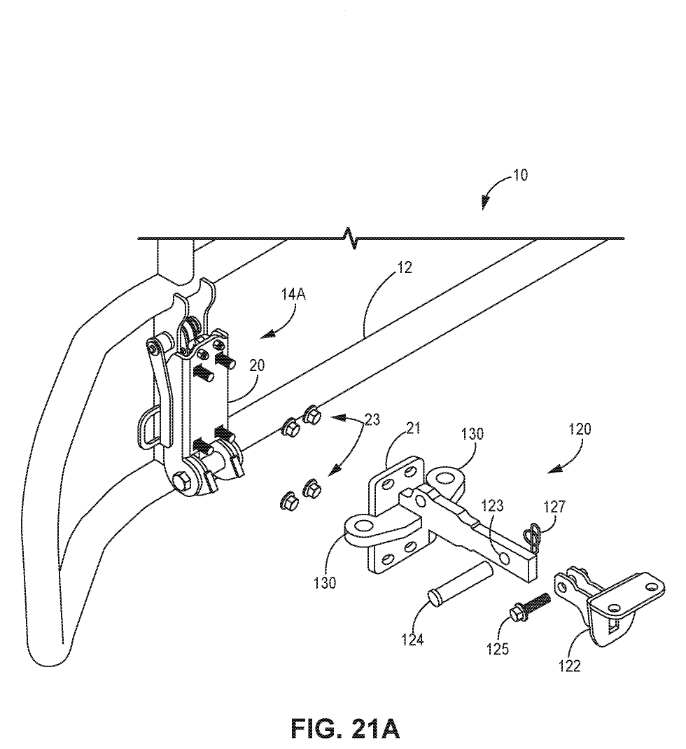

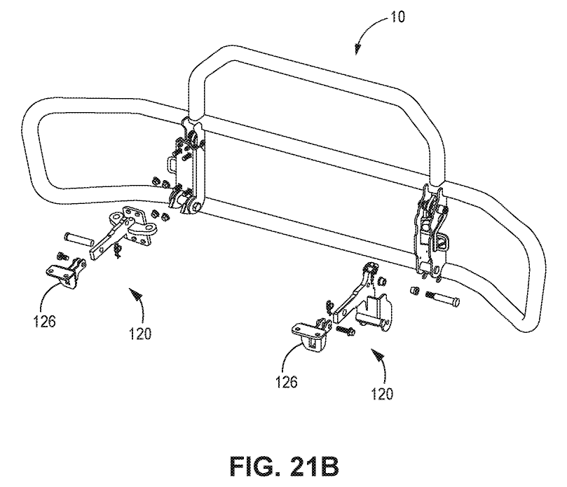

Turning to the figures in greater detail, various exemplary implementations of a grille guard system 10 are depicted in FIGS. 1A-24. In various implementations, the guard system 10 comprises a variety of optional assistive components, such as a detection offset 18, cam latch, spring / torsion lift assist, and / or sensor cap, as will be further described herein.

As shown in the implementation of FIG. 1A, the grille guard system 10 comprises a grille guard 12 and optionally comprise a variety of optional components, and at least one latch 14 disposed thereon that is selectively locked and operable via a handle 16 and configured to facilitate rotation of the grille guard 12 between positions, as has been previously described, for example in U.S. Patent 11,230,241 and U.S. Patent 9,114,771 which are hereby incorporated herein by reference in their entireties.

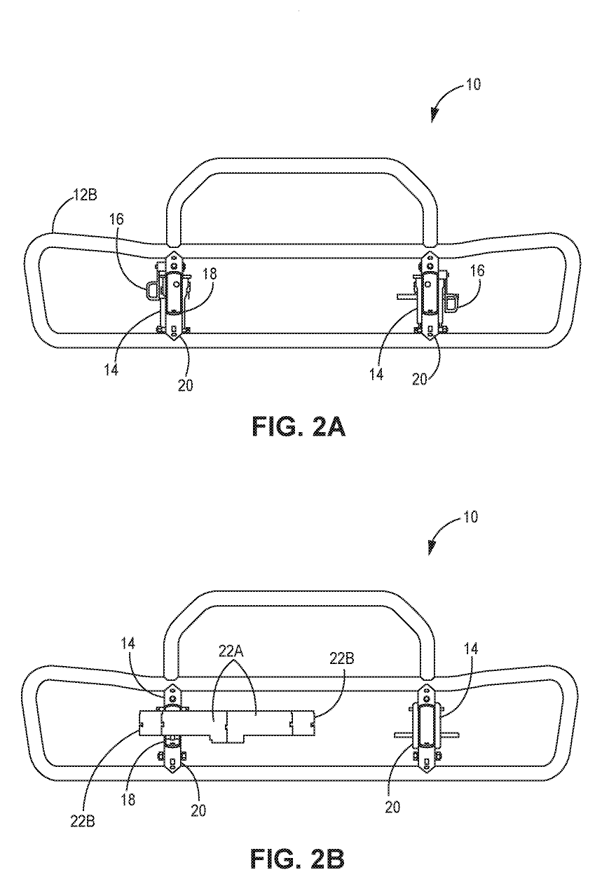

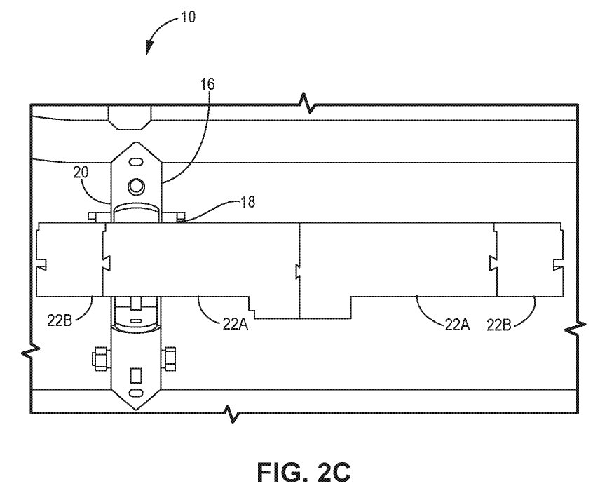

As is depicted in FIGS. 1A-24, both the grille guard 12 and the latch 14 can encompass a variety of sizes and shapes of grille guards 12, including both double-looped (shown at 12A in FIG. 1B) and single-looped (shown at 12B in FIG. 2A) configurations, which are among several grille guard configurations which are well-established in the art.

It is understood that the grille guard system 10 comprises the guard 12 itself along with associated components. In various implementations, the uppermost portion 12A of the guard 12—and therefore the axis of the grille guard 12 (axis G)—is moved/rotated from a first position (locked position) into a second position (open / unlocked position) about a hinge 8. In the second position the axis G is set at a substantially non-parallel angle to the front of the vehicle (axis V) as designated by reference arrow F, as is best shown in FIG. 1C. In certain implementations, this may be an acute, perpendicular, or obtuse angle.

As is shown in the implementations of FIGS. 1A-2B and elsewhere throughout, in various implementations the grille guard system 10 comprises one or more latches 14 having a detection offset 18 defined therein. As shown for example in the implementations of FIG. 2B and in particular FIG. 2C, the detection offset 18 is defined in the latch 14 housing 20 and is shaped or otherwise configured to accommodate the sensor path or field of view (FoV) 22 of a sensor such as radar, lidar or the like, that is, any sort of transmission / transmitter and detection system used to detect, monitor or otherwise analyze the location, distance, speed and the like of physical objects. The detection offset 18 may be an indentation, recess, or other setback as would be understood. In certain implementations, the detection offset 18 may from a generally trapezoidal void within the housing 20.

is, the geometries of the offset(s) 18 can be adapted to accommodate any various sensor paths of field of view that would be defined by the given sensor fitted to the underlying vehicle, which would be readily understood by those of skill in the art.

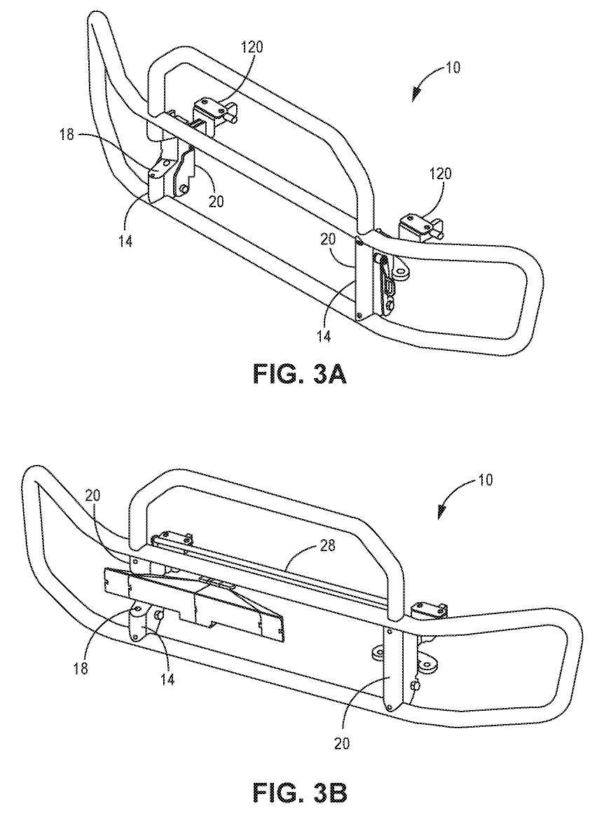

That is, in various implementations, the grille guard system 10 is configured to have one or more detection offset(s) 18 on the various latch(es) 14 that are adapted to accommodate the field of view or sensing of radar, lidar, cameras or other sensors and driver aids that are incorporated into the front end of the underlying vehicle. In various implementations, the field of view that is accommodated may be about 120º (shown at 22A), about 134º (shown at 22B), or other angles, as would be understood in the art. That As is shown in FIG. 3A, in various implementations the latches 14 can be attached to brackets 120 for mounting the system 10 to a vehicle, further described herein and in the incorporated references.

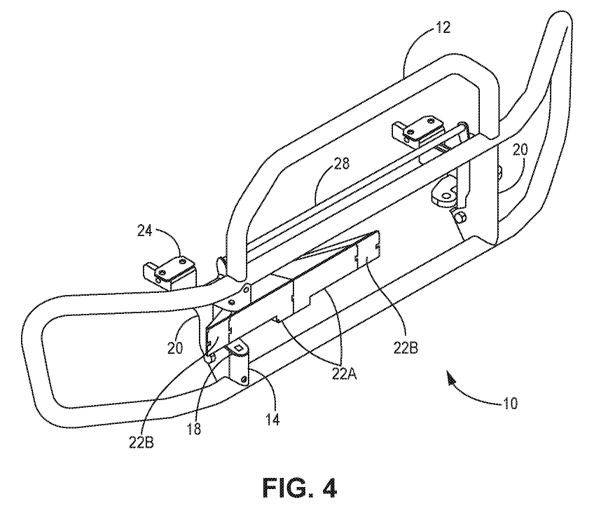

As shown in FIG. 3B and FIG. 4, in certain implementations the latches 14 can be actuated via a quick release bar 28, as would be appreciated. The quick release bar is further described in the incorporated references including U.S. Patent 11,230,241.

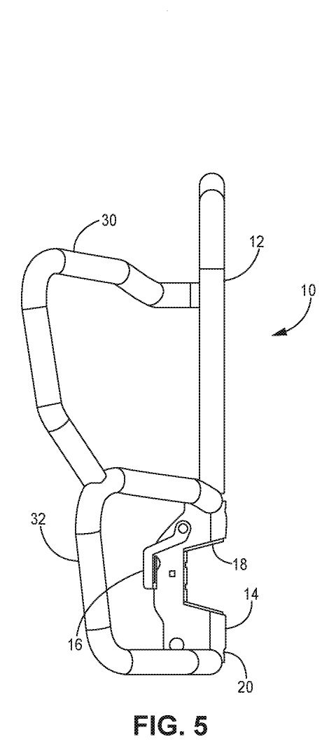

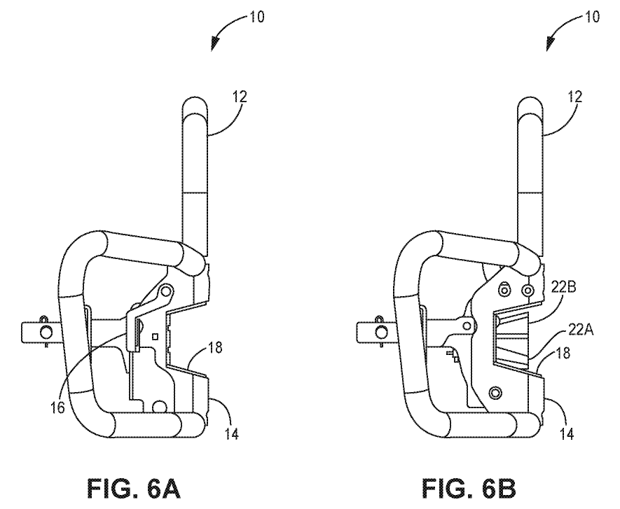

Turning now to FIG. 5, the grille guard system 10, according to these implementations, comprises a latch 14 disposed on the guard 12, which as mentioned above can comprise multiple loops 30, 32 adapted to curve around the front end of the vehicle and having certain ornamental features. FIGS. 6A-B and 7 depict further views of the system 10, according to these implementations.

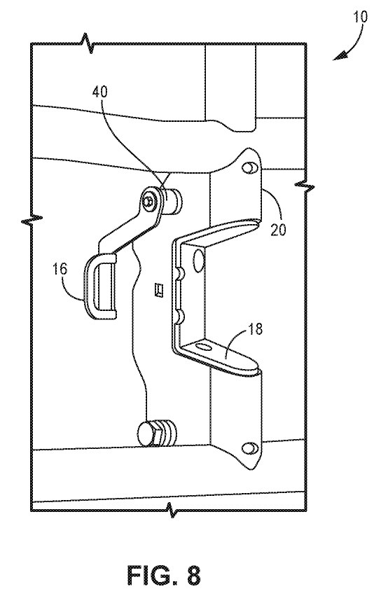

Turning to FIGS. 8-20, in various implementations of the system 10, the latch 14 comprises a cam assembly 66 (detailed below) comprising a camshaft 40 and cam 50 configured to assist in the smooth actuation and operation of the latch 14.

In these implementations, and as has been previously-described, the latch 14 is actuated via the handle 16, so as to be engaged in a locked position, securing the guard 12 in the upright position (first position referenced above), or disengaged and unlocked, thereby allowing for the pivoting of the guard 12 away from the vehicle into the second position referenced above. It is understood that in alternate implementations, the latch 14 can also be actuated by a bar, lever or other approach, as has also been previously described.

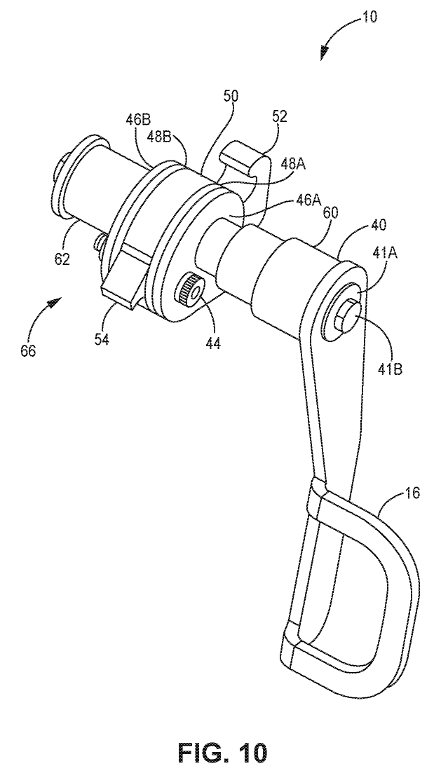

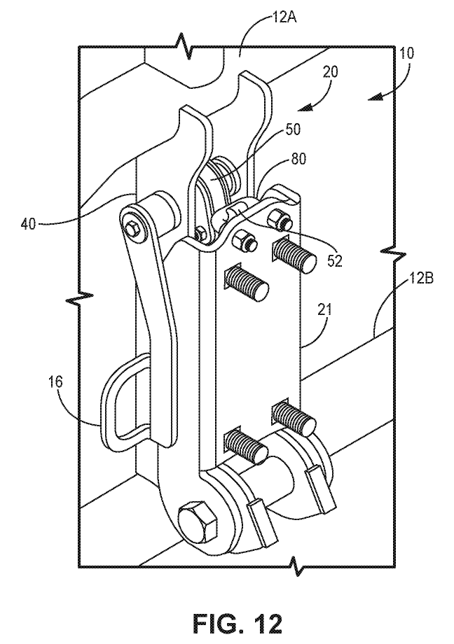

As shown in the implementation of FIG. 10, the handle 16 is secured so as to be in rotational communication with the camshaft 40, such as via fastener components 41A, 41B. In these implementations, the camshaft 40 is also in rotational communication with an internal cam 50 having a clasp 52 and driven catch 54 that are disposed on the cam 50 within the housing 20 of the latch 14 (as is shown further in FIG. 12), wherein the clasp

52 is in clasping communication with a bolt latch 80 such as a U-bolt latch 80 that is fixedly attached with the housing 20 backplate 21, which in turn is fixedly attached to the vehicle (not shown) in an upright position, as would be readily appreciated. It is understood that the interaction of the clasp 52 and bolt latch 80 allows for the selective pivoting of at least a portion of the guard 12 from the upright to forward configuration, as would be well understood.

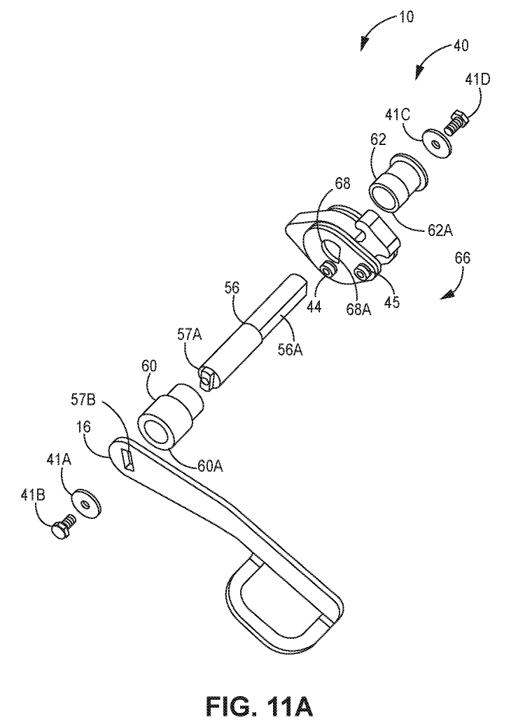

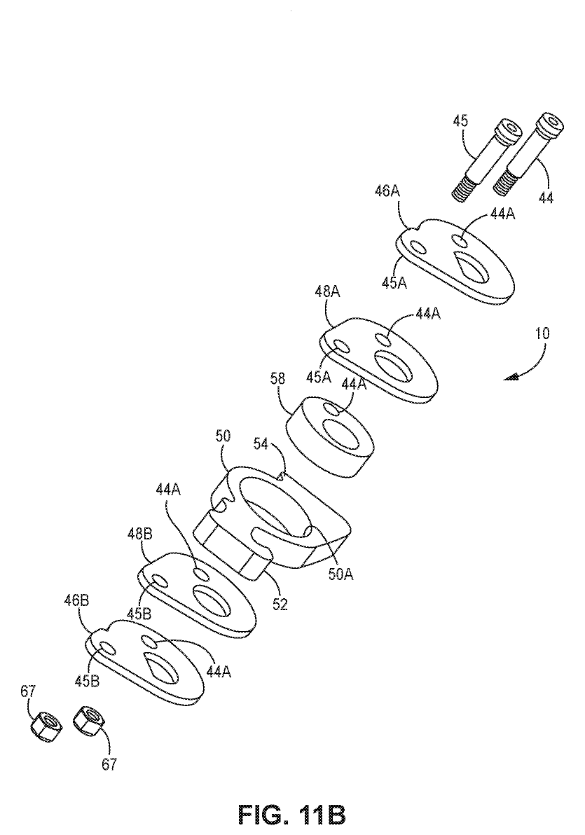

Continuing with FIG. 10 and also shown in FIGS. 11A-11B, the camshaft 40 according to these implementations optionally further comprises at least one rotating bolt 44, 45, in this implementation a first rotating bolt 44 and second rotating bolt 45 disposed through openings 44A, 45A defined in the in paired outer plates 46A, 46B and friction plates 48A, 48B, as are further shown in FIGS. 11A-11B.

Continuing with FIGS. 11A-11B, a cam assembly 66 is shown along with components connecting it to the handle 16 in certain implementations. In these implementations, the handle 16 is in operational communication with an internal axle 56 via a tongue-and-groove connection (shown at 57A/57B). The internal axle 56 in turn is configured to be rotationally secured within the cam assembly 66 via a axle opening 68 disposed therein. It is appreciated that in the implementation of FIGS. 10-11B, the axle opening 68 and axle 56 are in locked rotational communication via a locking D-shape configuration (shown at 56A and 68A) though of course other approaches are of course possible and contemplated.

Continuing with the implementations of FIGS. 11A-11B, the cam assembly 66 comprises an internal bearing 58 disposed within the cam 50 in the cam opening 50A defined therein. The first 44 and second bolts 45 are disposed through the cam assembly 66 and respective openings 44A, 45B in the various components, and secured via fasteners 67, and the handle 16 / axle 56 / cam assembly 66 unit is operationally secured via a first cam housing 60 and second cam housing 62, which have first cam housing opening 60A and second cam housing openings 62A defined therein. These are further secured with additional fastener components 41A, 41B, 41C, 41D. In these implementations, the bolts 44, 45, paired outer plates 46A, 46B and friction plates 48A, 48B rotate fixedly with the handle 16 and axle 56, and semi-independently of the cam assembly 66, as described herein.

FIG. 12 depicts the cam assembly 66 disposed within the housing 20 in clasped communication with the U-bolt latch 80 so as to secure the position of the guard 12 relative to the backplate 21, as would be appreciated. The latch 14 housing 20 is also shown, which in these implementations is selectively rotatable relative to the backplate 21 when the U-bolt latch 80 is not clasped by the clasp 52, as would be understood, so as to allow the guard 12 upper portion 12A to be rotated relative to the lower portion 12B of the guard 12 and / or face of the vehicle, as would be appreciated.

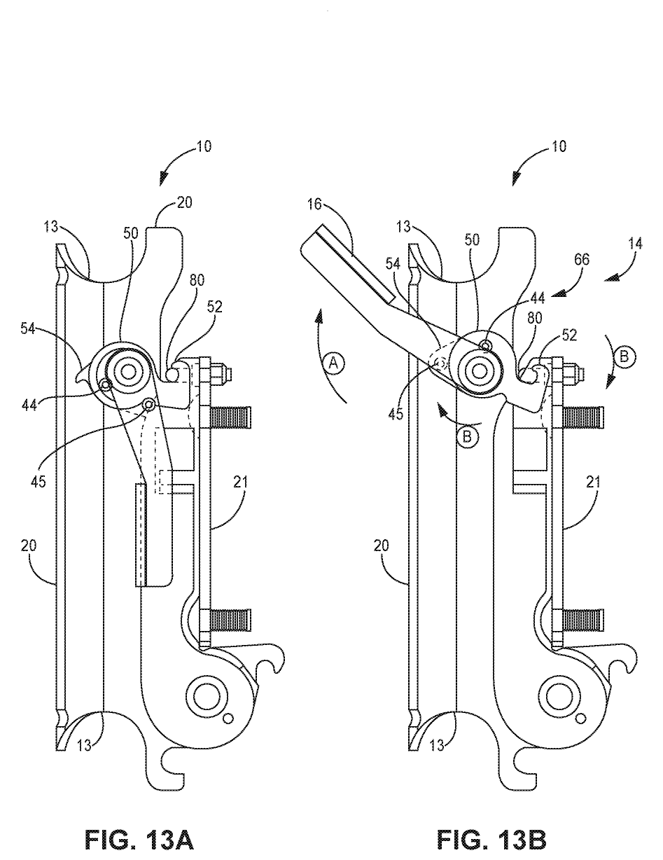

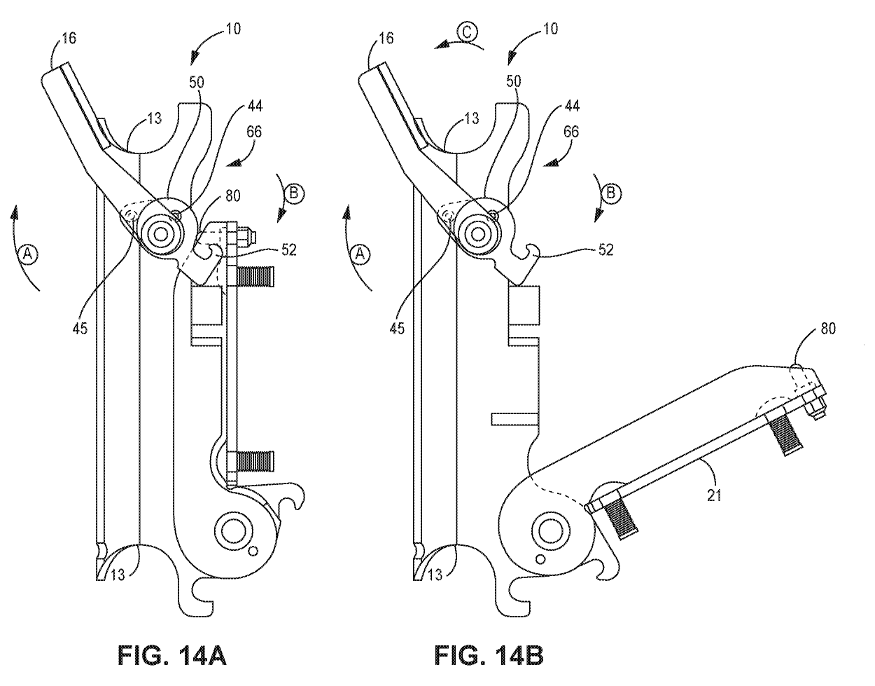

FIGS. 13A-14B depict the rotation and motion of the handle 16, cam assembly 66 and housing 20 in use according to certain implementations. As the handle 16 is urged upwards (reference arrow A), the cam assembly 66 rotates and the at least rotating bolt 44, 45 in turn rotates (reference arrow B) until it is in position to urge the driven catch 54 of the cam assembly 66, such that the cam assembly 66 is now urged into rotation by the bolt 45 which has been rotating with the handle 16 / axle 56 / outer plates 48A, 48B and the like, as described above, so as to urge the clasp 52 away from the U-bolt 80 and release the back plate 21 from the housing 20 so as to allow the rotation of the housing 20 and guard grasping portions 13 away from the vehicle face, represented by the backplate 21, as is shown in FIGS. 14A, 14B.

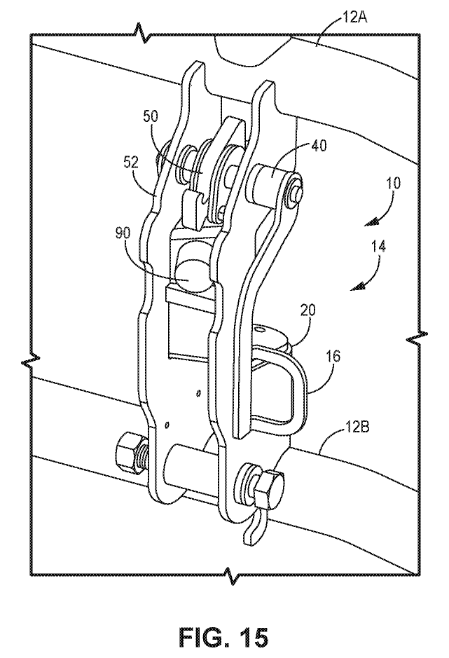

FIG. 15 depicts a further interior view of the latch 14 housing 20 having a stopper 90, such as a rubber stopper, disposed therein. As would be appreciated, further approaches to cushioning the transition between open and closed positions for the system 10 / guard 12 are possible.

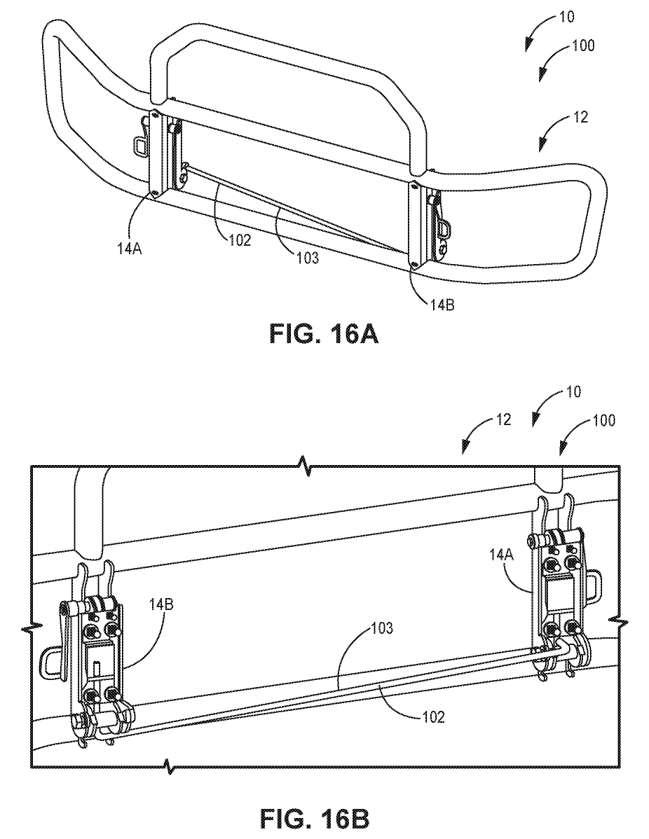

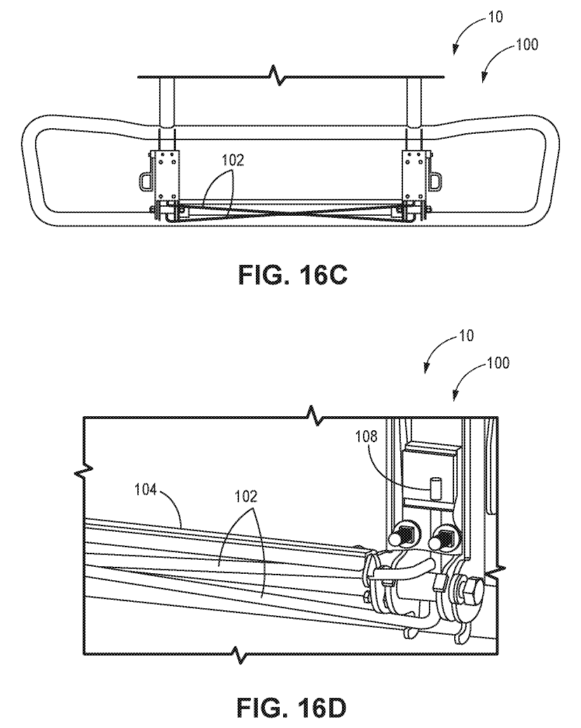

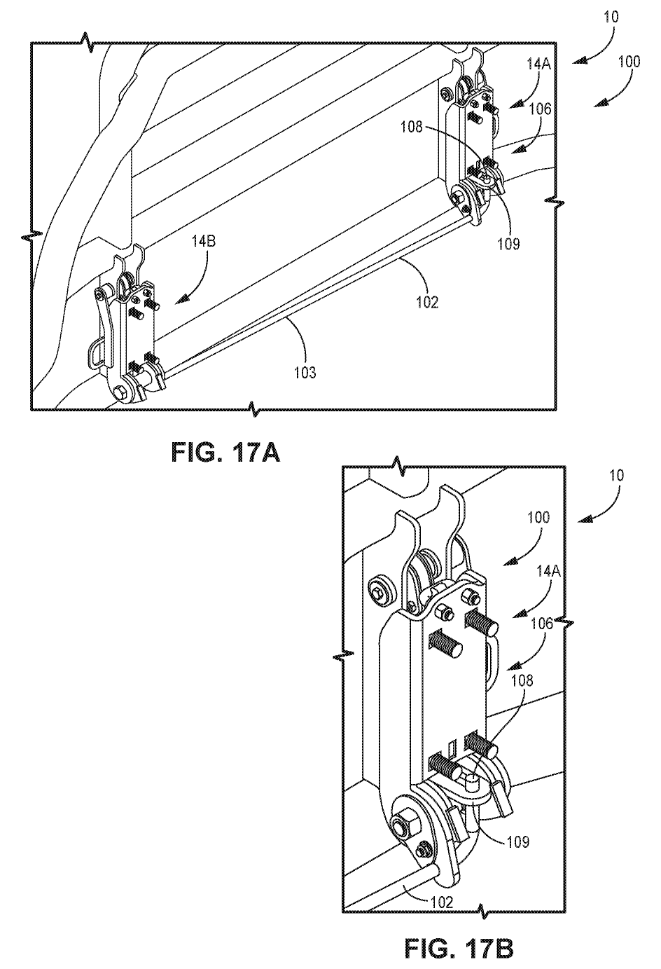

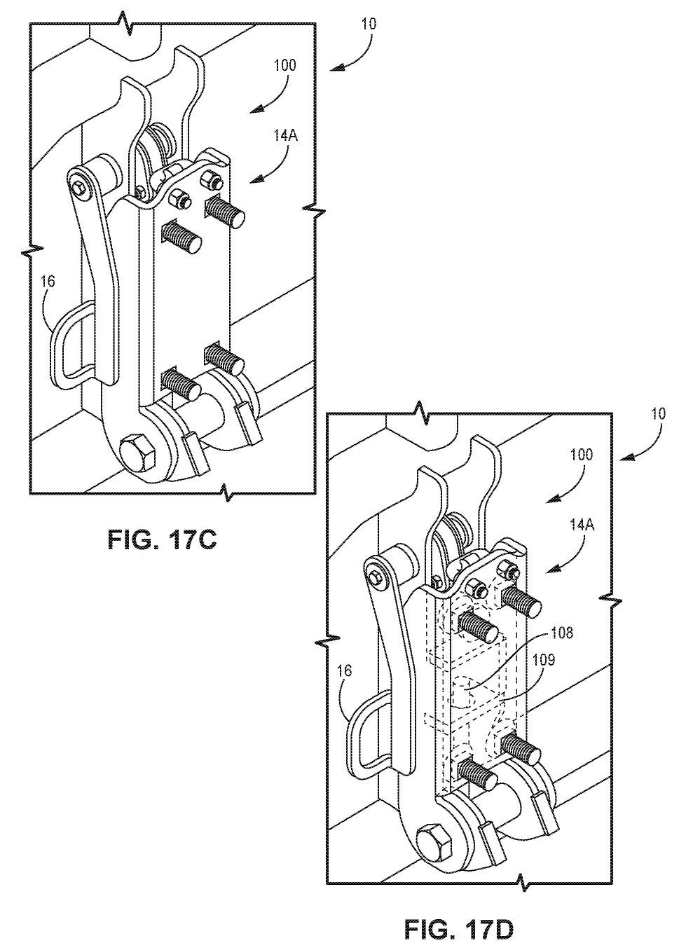

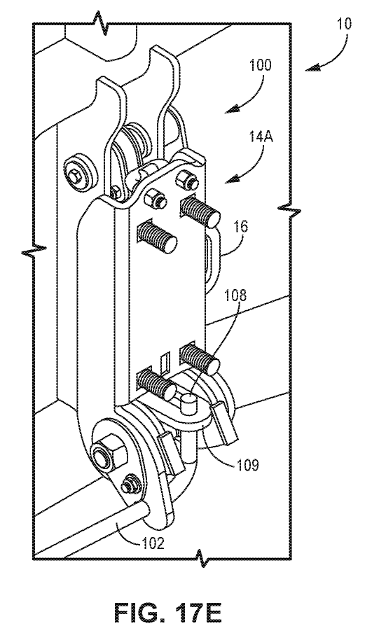

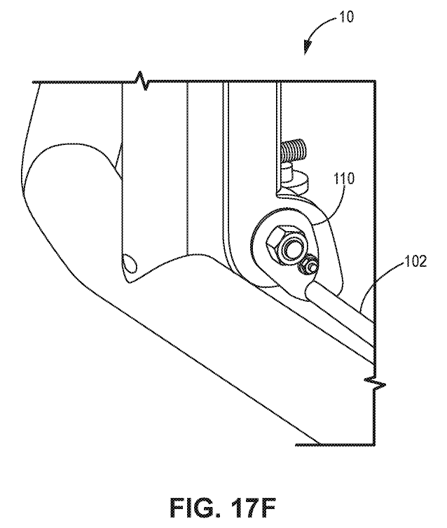

Certain implementations of the system 10, such as those shown in FIGS. 16A-17F, comprise a lift assist system 100 comprising one or more torsion bars 102. In these implementations, the lift assist system 100 provides a seamless assisted lift support to the user, such that the grille guard 12 is easier to reposition into the upright position because additional torsion is being applied via the latches 14A, 14B.

In the implementations of the system 10 shown in FIGS. 16A-17F having the lift assist system 100 at least one torsion bar 102 is provided between the latches 14A, 14B.

It is further understood that in these implementations, the torsion bar 102 comprises an elongated, resilient shaft 103 that is fixed at one or both ends and configured to store elastic potential energy when subjected to torsional deformation. As the guard 12 is extended into a pivoted, or open position, the torsion bar 102 is twisted about its longitudinal axis, thereby storing the potential energy to assist when returning the guard 12 to the up or closed / latched position, as would be understood.

Thus, in implementations such as this, the torsion bar 102 or bars 102A, 102B are spring steel torsion bar(s) 102 connected to one or more of the latches 14A, 14B. It will be appreciated that the torsion bar(s) 102A, 102B can comprise a number of possible materials, but that spring steel provides a useful example.

The incorporation of one or more torsion bars 102 as a lift assist system 100 thus improves ergonomic performance and reduces user effort, while also enabling compact and maintenance-free operation compared to conventional spring systems.

As is shown in the implementation of FIGS. 16B and 16D, the torsion bar(s) 102, 102A, 102B each have a torsion end 106 with a leverage rod 108 extending upward into a rod securement 109 and in rotational communication with one of the latches 14A or 14B, such that pivoting the latch 14A, 14B axis away from the face of the vehicle grille loads a torsional force onto the torsion bar 102, 102A, 102B that is discharged as the guard 12is repositioned into the upright, or closed / latched position, as would be appreciated.

It is further appreciated that in certain implementations only a single rod 102 may be utilized (FIGS. 16A-16B), such as for smaller guards 12 (more lightweight), while some implementations dual rods 102A, 102B may be employed, such as for larger guard 12 (heavier). Further spring assist approaches are also contemplated.

Additionally, in various implementations a coverage portion 104 may be fitted over the torsion bar 102 or bars 102A, 102B to prevent access / damage, as would be appreciated.

FIGS. 17A-17E depict additional views of the lift assist system 100 and torsion bar 102, according to certain implementations and detailing various implementations of the leverage rod 108 extending upward into a rod securement 109 as well as the securing catch 110 used to secure the torsion bar 102 in rotational communication.

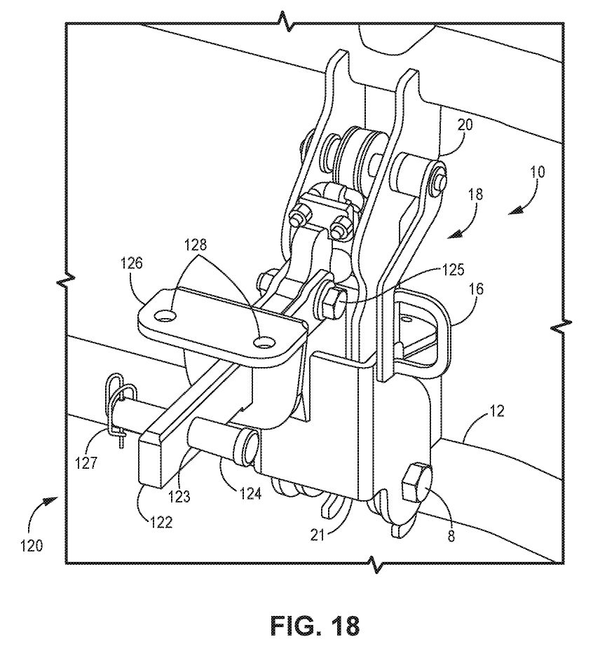

FIGS. 18-21 depict further implementations of the latch 14 comprising a vehicle coupling portion 120 or bracket 120 for the mounting of the system 10 to the frame, bumper, or other fixed portion of the vehicle. In various implementations, the bracket 120 is configured to align the detection offset 18 of the latch 14 properly relative to a forward-facing sensor integrated into the vehicle, as described above in FIGS. 1A-7.

Various additional detail on such coupling portions are described in the incorporated references including U.S. Patent 11,230,421. In these implementations, the bracket 120 has a vehicle coupling portion 122 with a defined opening 123 configured to accommodate a pin 124--secured by an optional cotter pin 127 in this implementation--as well as a mounting plate 126 having one or more openings 128 defined therein. A plate bolt 125 secures the mounting plate 126 to the bracket member 120A. Certain implementations also include tow mounts 130.

In these implementations, a mounting bolt 8 has optional bushings 9A, 9B that secure the bracket 120 to the guard 12 such that a portion of the bracket 120 comprises the backplate 21, as would be understood.

In various implementations, and as shown

In certain further implementations the system 10 may include the above disclosed grille guard 12, detection offset 18, cam assembly 66, and /or torsion lift assist system 100.

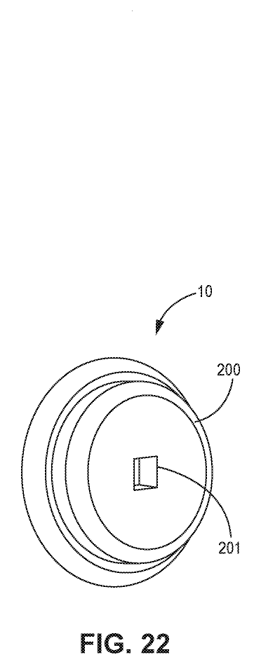

As shown in FIGS. 22-24, certain implementations of the grill guard system optionally include a cap 200 comprising an angled opening 201 defined therein. The opening according to these implementations is configured to constrain the field of view of a proximity sensor such as a parking sensor so as to avoid the detection of a mounted grille guard. In these implementations, the cap 200 may be placed in proximity to or “over” such a sensor 202 for control of the sensor signal or field of view 204, as shown in FIGS.

23-24. These implementations may include implementations where there is no latch, and instead the guard 12 is mounted directly to the vehicle, such as a pickup truck or SUV.

It would be understood that modifications or addition to the front end of a vehicle such as the described grille guard 12 may block, trigger or otherwise distort the received signal from the field of view 204 from a front mounted sensor 202, such as a parking sensor, rendering the sensor not useful. That is, for example, the sensor 202 may record false positives as it is constantly detecting the presence of the system 10 guard 12. Or the sensor may otherwise cease to function properly. As such, disclosed herein is a 3D printed, or otherwise formed, cap 200 that may be placed over a sensor 202 to channel the sensor via the channeled or angled opening 201 such that the sensor cloud 204A is constrained from detecting the guard 12. It is understood that the angles of the channel in the opening can be configured to accurately match the guard 12 opening based on the specific configuration of the guard, mounting distance and sensor location.

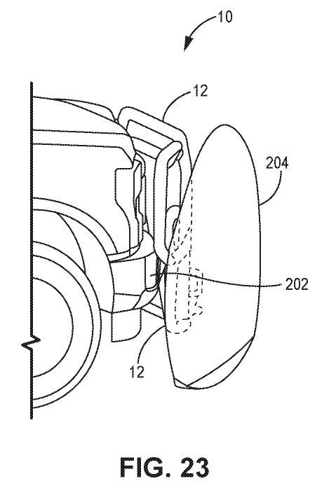

FIG. 22 shows one implementation of the cap / cover 200 configured to redirect sensor signals. FIG. 23 shows a parking sensor on a vehicle with a grille guard 12 installed.

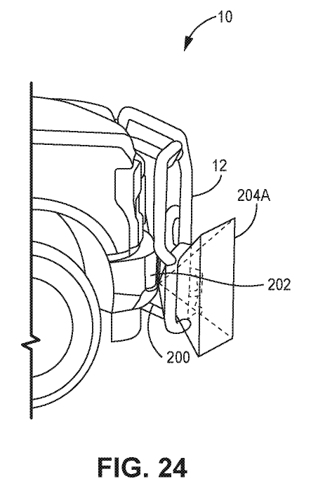

FIG. 24 shows the alteration of the sensor signal 204 cloud of FIG. 23 where via the inclusion of the cap / cover 200 from FIG. 22. Here, it can be seen that the sensor 202 has been focused 204A and is no longer impacted by the grille guard 12, as would be readily appreciated.

Although the disclosure has been described with reference to preferred embodiments, persons skilled in the art will recognize that changes may be made in form and detail without departing from the spirit and scope of the disclosed apparatus, systems and methods.

What is claimed is:

1. A grille guard latch, comprising:
a. a handle;
b. a cam assembly, comprising:
i. a cam comprising a clasp and a catch; and
ii. a rotating bolt configured to urge the catch and clasp in response to rotation of the handle;
c. a backplate comprising a U-bolt in operational locking communication with the clasp; and
d. a housing comprising a detection offset,
wherein the urging of the catch and clasp grasps or releases the U-bolt from the clasp to allow for selective rotation of the housing relative to the backplate.

2. The grille guard latch of claim 1, wherein the detection offset comprises a recessed portion configured to accommodate a sensor field of view of a vehicle-mounted radar or lidar system.

3. The grille guard latch of claim 1, wherein the detection offset defines a trapezoidal void formed in the latch housing and aligned to permit an unobstructed sensor field of view of at least 120 degrees.

4. The grille guard latch of claim 1, wherein the detection offset comprises a geometry adapted to conform to a sensor path.

5. The grille guard latch of claim 1, wherein the latch further comprises a bracket configured to align the detection offset relative to a forward-facing sensor integrated into the vehicle.

6. The grille guard latch of claim 1, in operational communication with a grille guard assembly and at least one torsion bar configured to provide lift assist.
